(19) United States
(12) Patent Application Publication
(10) Pub. No.: US 2025/0299221 A1
(43) Pub. Date: Sep. 25, 2025

(54) INFORMATION PROCESSING DEVICE, INFORMATION PROCESSING METHOD, AND PROGRAM

(71) Applicant: SONY GROUP CORPORATION, Tokyo (JP)

(72) Inventors: Kazuki KAWAMURA, Tokyo (JP); Kei TATENO, Tokyo (JP); Takuma UDAGAWA, Tokyo (JP); Masahiro YOSHIDA, Tokyo (JP)

(21) Appl. No.: 18/868,877

(22) PCT Filed: May 16, 2023
(86) PCT No.: PCT/JP2023/018214

§ 371 Date: Nov. 25, 2024

(30) Foreign Application Priority Data
Jun. 1, 2022 (JP) 2022-089436

(51) Int. Cl. G06Q 30/0251

(52) U.S. Cl. CPC G06Q 30/0251

(57) ABSTRACT

The present technology relates to an information processing device, an information processing method, and a program that allow appropriate users to be directed to target content.

The selection unit selects a first measure content to be provided to a prescribed user among multiple first measure contents with different measures for inducement to target content and selects a second measure content to be provided to the prescribed user among multiple second measure contents with different measures for directing a user who has accessed the selected first measure content to the target content. The selection is performed on the basis of user information which is information about a user who has accessed the target content among users who have accessed the second measure content via the first measure content and an evaluation value for the target content by a user who has accessed the target content via the second measure content. The present technology can be applied to an information processing device, or the like.

### TECHNICAL FIELD

The present technology relates to an information processing device, an information processing method, and a program, and more particularly, relates to an information processing device, an information processing method, and a program that allow appropriate users to be directed to target content.

### BACKGROUND ART

In recent years, various techniques have been developed to direct more users to target content, such as products being advertised.

For example, in analyzing the relationship between an advertisement image and feature values of an advertisement image and key performance indicators (KPIs) such as click rates, a technique has been devised to dynamically calculate optimal parameters by learning for example using machine learning and to generate more effective advertisement images using the parameters (see, for example, PTL 1).

### CITATION LIST

### Patent Literature

[PTL 1]
JP 2018-77615A

### SUMMARY

### Technical Problem

However, the technique disclosed in PTL 1 directs users to target content, regardless of whether the users are suitable for the target content, in order to generate advertising images that are highly effective for example in terms of click rates. Therefore, there is a risk that the reputation of the target content may be adversely affected by negative evaluations of the target content by users who are not suitable for the target content. Therefore, there has been a demand to provide an approach for guiding appropriate users to target content but this is yet to be fulfilled.

The present technology has been made in view of such a situation and is directed to directing suitable users to target content.

### Solution to Problem

One aspect of the present technology relates to an information processing device or a program causing a computer to function as the information processing device, the information processing device includes a selection unit configured to select a first measure content to be provided to a prescribed user among multiple first measure contents with different measures for inducement to target content and select a second measure content to be provided to the prescribed user among multiple second measure contents with different measures for directing a user who has accessed the selected first measure content to the target content, and the selection unit is configured to select the first measure content and the second measure content on the basis of user information about a user who has accessed the target content among users who have accessed the second measure content via the first measure content and evaluation value for the target content by a user who has accessed the target content via the second measure content.

An information processing method according to one aspect of the present technology includes the step of causing an information processing device to select a first measure content to be provided to a prescribed user among multiple first measure contents with different measures for inducement to target content and to select a second measure content to be provided to the prescribed user among multiple second measure contents with different measures for directing a user who has accessed the selected first measure content to the target content, and in processing in the selection step, the first measure content and the second measure content are selected on the basis of user information which is information about a user who has accessed the target content among users who have accessed the second measure content via the first measure content and an evaluation value for the target content by a user who has accessed the target content via the second measure content.

According to one aspect of the present technology, a first measure content to be provided to a prescribed user is selected among multiple first measure contents with different measures for inducement to target content, and a second measure content to be provided to the prescribed user is selected among multiple second measure contents with different measures for directing a user who has accessed the selected first measure content to the target content. The selection is performed on the basis of user information which is information about a user who has accessed the target content among users who have accessed the second measure content via the first measure content and an evaluation value for the target content by a user who has accessed the target content via the second measure content.

In order to implement an information processing device according to one aspect of the present technology, the program to be executed by a computer can be provided by being transmitted via a transmission medium or by being recorded on a recording medium.

### BRIEF DESCRIPTION OF DRAWINGS

FIG. 1 is a block diagram of an exemplary configuration of an information processing system according to a first embodiment to which the present technology is applied.

FIG. 2 illustrates an exemplary overview of processing performed by the information processing system in FIG. 1.

FIG. 3 illustrates an exemplary overview of another kind of processing performed by the information processing system in FIG. 1.

FIG. 4 illustrates another exemplary overview of processing performed by the information processing system in FIG. 1.

FIG. 5 is an example of a user information table.

FIG. 6 illustrates an example of user characteristic information.

FIG. 7 is a flowchart for illustrating user information table registration processing performed by the information processing system in FIG. 1.

FIG. 8 is a flowchart for illustrating optimization processing performed by the information processing system in FIG. 1.

FIG. 9 is a block diagram of an exemplary configuration of an information system according to a second embodiment to which the present technology is applied.

FIG. 10 illustrates an overview of processing performed by the information processing system in FIG. 9.

FIG. 11 illustrates a screen display example.

FIG. 12 is a flowchart for illustrating optimization processing performed by an information processing device in FIG. 9.

FIG. 13 is a block diagram of an exemplary hardware configuration of a computer.

### DESCRIPTION OF EMBODIMENTS

Modes for carrying out the present technology (hereinafter referred to as embodiments) will be described below. Note that the description will be made in the following order.

1. First embodiment (information processing device that selects measure content on the basis of transmission degrees)

2. Second embodiment (information processing device that selects measure content on the basis of an effect estimation model)

3. Computer

### First Embodiment

### <Exemplary Configuration of Information Processing System>

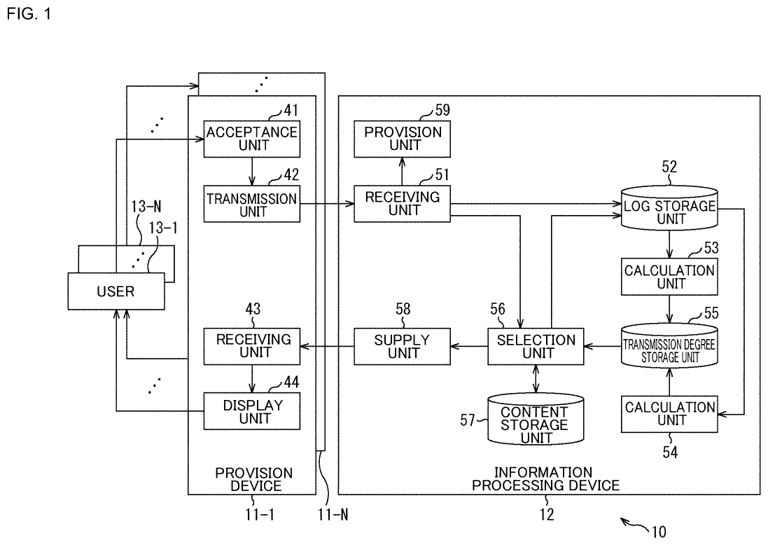

FIG. 1 is a block diagram of an exemplary configuration of an information processing system according to a first embodiment to which the present technology is applied.

The information processing system 10 in FIG. 1 is established as N provision devices 11-1 to 11-N (where Nis an integer of 1 or more), and the information processing device 12 are connected over a network (not shown). The information processing system 10 directs users 13-1 to 13-N, who use the provision devices 11-1 to 11-N, respectively, to target content. According to the first embodiment, the target content is for example a product being advertised, an article on a website, a video, music, a movie, a book, a game, or an application in recruitment.

In the following, when it is not necessary to distinguish between the provision devices 11-1 to 11-N, they are collectively referred to as provision device 11. Similarly, the users 13-1 through 13-N are collectively referred to as user 13.

The provision device 11 includes an acceptance unit 41, a transmission unit 42, a receiving unit 43, and a display unit 44.

The acceptance unit 41 accepts an operation from the user 13 and supplies an input signal representing the input content corresponding to the operation to the transmission unit 42. Specifically, the acceptance unit 41 accepts a prescribed operation to access first measure content from the user 13 and supplies an input signal indicating access to the first measure content as the input content to the transmission unit 42. The first measure content is content that directs users to the target content. According to the first embodiment, the first measure content is content such as an advertisement, an article title, a thumbnail, and cover art. For a single piece of target content, multiple types of first measure content are provided with different measures to direct the user 13 to the target content.

The acceptance unit 41 receives for example a click operation from the user 13 for the first measure content and provides an input signal to the transmission unit 42 indicating access to the second measure content via the first measure content as input content. The second measure content is content that induces the user 13 who has accessed the first measure content to the second measure content. According to the first embodiment, the second measure content is for example a web page that provides detailed information on the target content. For a single target content, multiple types of second promotional content, which direct users 13 who accessed the first promotional content to the target content, are provided, with each type employing a different strategy.

The acceptance unit 41 receives for example a click operation for the second measure content from the user 13 and provides an input signal representing access to the target content via the second measure content as input content to the transmission unit 42. The acceptance unit 41 accepts an input operation for an evaluation value for the target content from the user 13 and provides an input signal expressing the evaluation value as input content to the transmission unit 42. The evaluation value is, for example, a value representing a level or rank of satisfaction with the target content, the quality of the target content and is expressed for example on a five-point scale.

The transmission unit 42 transmits the input signal supplied from the acceptance unit 41, together with user characteristic information about the user 13, to the information processing device 12 over a network which is not shown. The user characteristic information includes a user ID that uniquely identifies the user 13, the user 13's age and gender registered by the user 13, and information representing the characteristics of the user 13, such as websites visited by the user 13 that are collected by the provision device 11.

The receiving unit 43 receives the first measure content and the second measure content transmitted from the information processing device 12 via the network, which is not shown, and provides them to the display unit 44.

The display unit 44 displays the first measure content and the second measure content supplied by the receiving unit 43 to the user 13. If the user 13 is interested in the target content after viewing the first measure content or the second measure content displayed on the display unit 44, the user 13 performs for example a click operation on the first measure content or the second measure content. The user 13 performs for example a click operation on the second measure content to access the target content, and then performs an operation to input an evaluation value for the target content.

The information processing device 12 includes a receiving unit 51, a log storage unit 52, calculation units 53 and 54, a transmission degree storage unit 55, a selection unit 56, a content storage unit 57, a supply unit 58, and a provision unit 59.

The receiving unit 51 receives input signals and user characteristic information transmitted from the provision device 11 over a network that is not shown in the figure. The receiving unit 51 supplies an input signal indicating access to or an evaluation value for second measure content or the target content and user characteristic information to the log storage unit 52. The receiving unit 51 supplies an input signal indicating access to the first measure content or the second measure content and the user characteristic information to the selection unit 56. The receiving unit 51 provides an input signal indicating access to the target content and the user characteristic information to the provision unit 59.

The log storage unit 52 updates a user information table stored therein on the basis of the input signal and user characteristic information supplied by the receiving unit 51, and the type of the first measure content and the type of the second measure content supplied by the selection unit 56.

The user information table includes the user ID of each user 13 in association with access information and represents a history of the access information of each user 13. The access information includes the type of the first measure content or the second measure content accessed by the user 13, information indicating whether the user has accessed the second measure content via that first measure content or the target content via that second measure content, and the evaluation value for the target content. Here, the information that indicates whether there has been access to the second measure content via the first measure content or access to the target content via the second measure content is represented as 1 for the presence of access and 0 for the absence of access.

The calculation unit 53 (first calculation unit) segments the users 13-1 to 13-N into groups on the basis of shared characteristics among the users 13, according to the user characteristic information of each user 13. For each segment, the calculation unit 53 obtains the type of the first measure content accessed by the users 13 belonging to the segment, information indicating whether the second measure content has been accessed, and information indicating whether the target content has been accessed, from the user information table stored in the log storage unit 52.

The calculation unit 53 calculates, for each segment and for each type of the first measure content, a first transmission degree that represents how accurately the first measure content can convey the content of the target content to the users 13 belonging to the segment.

Specifically, the calculation unit 53 calculates, for each segment and for each type of the first measure content, the first transmission degree on the basis of the user information about the user 13 who has accessed the target content among the users 13 belonging to the segment who have accessed the second measure content via the first measure content. For example, the calculation unit 53 calculates the first transmission degree for each type of first measure content according to the following expression (1).

$$\begin{matrix}[ Math . 1 ] & \\ t {r}_{1}^{c 1 , u} = \frac{\sum {i}_{2}}{\sum {i}_{1}} u ∈ U , c 1 ∈ C 1 & ( 1 )\end{matrix}$$

In expression (1), u is a set of users 13 that belong to each segment in the set U of all users 13. In the expression, c1 represents each type in the set C1 of all types of the first measure content. In addition, i₁ is information indicating whether there has been access to the second measure content via the first measure content, and i₂ is information indicating whether there has been access to the target content via the second measure content. In addition, tr₁^{c1, u} is a first transmission degree for the first measure content of type c1 for the set u.

According to expression (1), the first transmission degree is the ratio of the number of users 13 who have accessed the target content via the second measure content to the number of users 13 who have accessed the second content via the first measure content, for each segment and for each type of first measure content.

The calculation unit 53 supplies the first transmission degree calculated as described above for each segment and for each type of first measure content to the transmission degree storage unit 55 for storage.

The calculation unit 54 (second calculation unit) segments the users 13-1 to 13-N into groups on the basis of the users 13 that have common characteristics according to the user characteristic information of each user 13. The calculation unit 53 obtains, for each segment, the type of the second measure content accessed by the user 13 belonging to the segment and the evaluation value from the user information table stored in the log storage unit 52.

The calculation unit 53 calculates, for each segment and for each type of second measure content, a second transmission degree that indicates how accurately the second measure content can convey the content of the target content to the users 13 belonging to the segment, on the basis of the evaluation value. Specifically, the calculation unit 53 calculates the second transmission degree for each segment and for each type of second measure content on the basis of the evaluation values for the target content given by users 13 belonging to the segment who have accessed the target content via the second measure content. For example, the calculation unit 53 calculates the second transmission degree for each segment and for each type of second measure content according to the following expression (2).

$$\begin{matrix}[ Math . 2 ] & \\ t {r}_{2}^{{c}_{2} , u} = \frac{\sum r}{\sum 1} u ∈ U , c 2 ∈ C 2 & ( 2 )\end{matrix}$$

In expression (2), u is a set of users 13 that belong to each segment in the set U of all users 13. In the expression, c2 represents each type in the set C2 of all types of second measure content. In addition, r is an evaluation value for the target content accessed via the second measure content. In addition, tr₂^{c2, u} is a second transmission degree for the second measure content of type c2 for the set u.

According to expression (2), the second transmission degree is the average of the evaluation values for the target content by the users 13 who have accessed the target content via the second measure content, for each segment and for each type of second measure content.

The calculation unit 54 supplies the second transmission degree calculated as described above for each segment and for each type of second measure content to the transmission degree storage unit 55 for storage.

The transmission degree storage unit 55 stores the first transmission degree supplied from the calculation unit 53 and the second transmission degree supplied from the calculation unit 54.

The selection unit 56 selects one type of first measure content randomly from multiple types of first measure content stored in the content storage unit 57 in response to an input signal supplied from the receiving unit 51.

Alternatively, the selection unit 56 reads out the first transmission degree for the segment corresponding to the user characteristic information supplied from the receiving unit 51 together with the input signal from the transmission degree storage unit 55, in response to the input signal. On the basis of the first transmission degree, the selection unit 56 selects an optimal type of first measure content to be provided to the user 13 among the types of first measure content stored in the content storage unit 57, according to the following expression (3).

$$\begin{matrix}[ Math . 3 ] & \\ c {1}^{′} = arg {max}_{c 1 ∈ C 1} {tr}_{1}^{c 1 , u} u ∈ U , c 1 ∈ C 1 & ( 3 )\end{matrix}$$

In expression (3), u, c1, and tr₁^{c1, u} are the same as those in expression (1). In the expression, c1′ is the optimal type of first measure content.

According to expression (3), the selection unit 56 selects the type of the first measure content that has the largest first transmission degree for the user 13 belonging to the segment corresponding to the user characteristic information of the user 13 as the type of the first measure content that is optimal for the user 13.

The selection unit 56 supplies the selected type of first measure content to the log storage unit 52. The selection unit 56 reads the selected first measure content from the content storage unit 57 and supplies it to the supply unit 58.

The selection unit 56 randomly selects one type of second measure content from the multiple types of second measure content stored in the content storage unit 57 in response to the input signal supplied from the receiving unit 51.

Alternatively, the selection unit 56 reads out a second transmission degree for the segment corresponding to the user characteristic information supplied from the receiving unit 51 together with the input signal from the transmission degree storage unit 55 in response to the input signal. On the basis of the second transmission degree, the selection unit 56 selects the optimal type of second measure content to be provided to user 13 among the types of second measure content stored in the content storage unit 57, according to the following expression (4).

$$\begin{matrix}[ Math . 4 ] & \\ c {2}^{′} = arg {max}_{c 2 ∈ C 2} {tr}_{2}^{c 2 , u} u ∈ U , c 2 ∈ C 2 & ( 4 )\end{matrix}$$

In expression (4), u, c2, and tr₂^{c2, u} are the same as those in expression (2). In the expression, c2′ is the type of optimal second measure content.

According to expression (4), the selection unit 56 selects the type of second measure content that has the largest second transmission degree for the user 13 belonging to the segment corresponding to the user characteristic information about the user 13 as the type of second measure content that is optimal for the user 13.

The selection unit 56 supplies the selected type of second measure content to the log storage unit 52. The selection unit 56 reads the selected type of second measure content from the content storage unit 57 and supplies the content to the supply unit 58.

The content storage unit 57 stores multiple types of first measure content with different measures for directing the user 13 to the target content. The content storage unit 57 stores multiple types of second measure content with different measures for directing the user 13 who has accessed the first measure content to the target content.

The supply unit 58 supplies (transmits) the first measure content or second measure content supplied by the selection unit 56 to the provision device 11 of the user 13 corresponding to the user characteristic information referred to during the selection operation by the selection unit 56, over a network that is not shown. The first measure content or second measure content is received by the receiving unit 43 and displayed on the display unit 44.

The provision unit 59 provides the target content to the user 13 corresponding to the user characteristic information on the basis of the input signal supplied from the receiving unit 51 and the user characteristic information.

### <Exemplary Overview of Processing by Information Processing System>

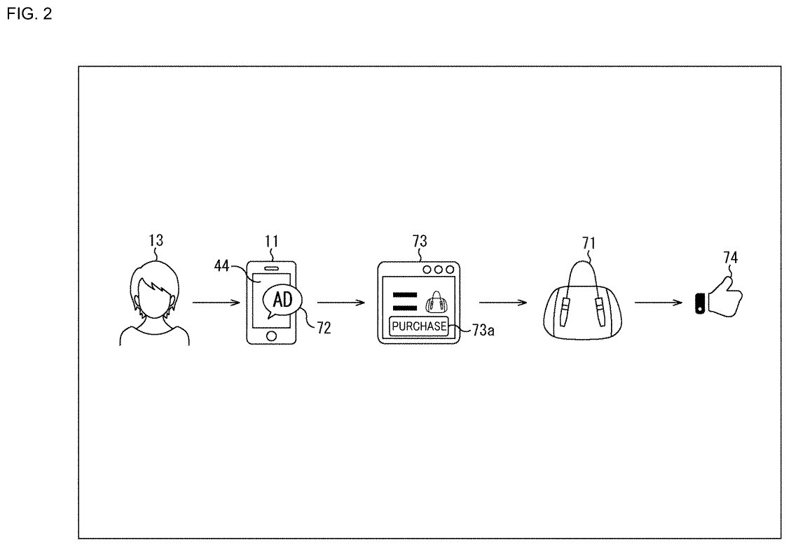

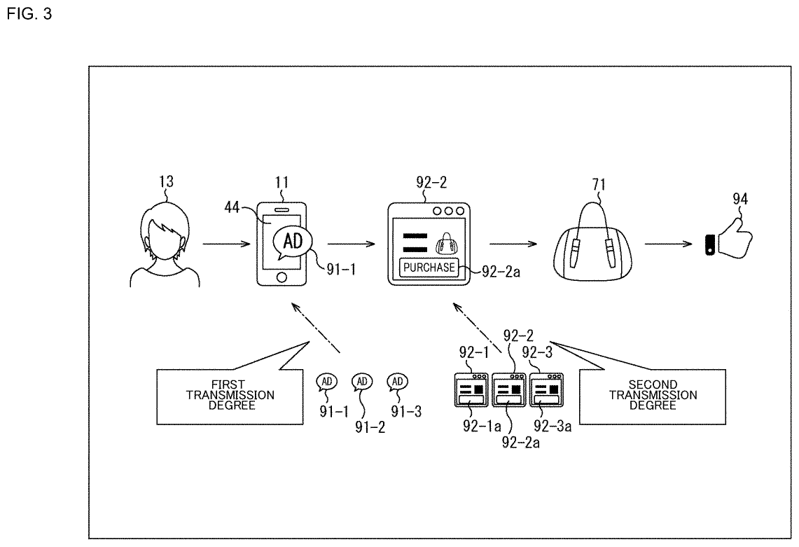

FIGS. 2 and 3 illustrate an exemplary overview of processing carried out by the information processing system 10 in FIG. 1.

In the examples in FIGS. 2 and 3, the user 13 purchases a bag through electronic commerce (EC). In this case, the target content is the bag 71 being advertised. The first measure content is, for example, an advertisement for the bag 71, and the second measure content is, for example, a product introduction page for the bag 71.

The information processing system 10 first calculates the first transmission degree and the second transmission degree by having the provision device 11 display the advertisement 72 and product introduction page 73 randomly selected by the information processing device 12.

Specifically, as shown in FIG. 2, when the user 13 operates the provision device 11 to access a first measure content, the selection unit 56 randomly selects a first measure content. As a result, the display unit 44 displays the advertisement 72, which is the randomly selected first measure content.

The user 13 who has viewed the advertisement 72 and is interested in the bag 71 accesses second measure content by clicking on the advertisement 72. As a result, the selection unit 56 randomly selects second measure content. As a result, the display unit 44 displays, as an interaction, the product introduction page 73, which is the randomly selected second measure content.

The user 13 who has viewed the product introduction page 73 and decided to purchase the bag 71 accesses the bag 71 by clicking on a purchase button 73a included in the product introduction page 73. As a result, the provision unit 59 performs processing to purchase the bag 71 and provides the bag 71 to the user 13 as an interaction. After obtaining the bag 71, the user 13 uses the provision device 11 to input an evaluation value 74 for the bag 71 as a product review. The evaluation value 74 is transmitted to the information processing device 12.

The random display of the first measure content as described above is repeated until the number of entries by the users 13 belonging to each segment registered in the user information table reaches a prescribed number for each type of first measure content. Then, a first transmission degree is calculated for each segment and for each type of first measure content. The random display is repeated similarly for the second measure content, and a second transmission degree is calculated. In the example in FIG. 2, the first transmission degree is a conversion rate, and the second transmission degree is a product evaluation value by the user 13 for the bag 71 purchased by the user 13.

After calculating the first and second transmission degrees, the information processing system 10 optimizes the first measure content to be provided to the user 13 on the basis of the first transmission degree. The information processing system 10 optimizes the second measure content to be provided to the user 13 on the basis of the second transmission degree.

Specifically, in the example in FIG. 3, advertisements 91-1 to 91-3 are stored in the content storage unit 57 as three types of selection candidates for first measure content. In addition, the product introduction pages 92-1 to 92-3 are stored in the content storage unit 57 as three types of selection candidates for the second measure content. The product introduction pages 92-1 to 92-3 include purchase buttons 92-1a to 92-3a, respectively that are operated when purchasing bag 71.

As shown in FIG. 3, when the user 13 accesses the first measure content by operating the provision device 11, the selection unit 56 selects the advertisement 91-1 that has the largest first transmission degree of the segment to which the user 13 belongs, from the three types of advertisements 91-1 to 91-3 stored in the content storage unit 57. As a result, the display unit 44 displays the advertisement 91-1.

The user 13, who has viewed advertisement 91-1 and becomes interested in bag 71, clicks on the advertisement 91-1 to access the second measure content. As a result, the selection unit 56 selects the product introduction page 92-2, which has the highest second transmission degree for the segment to which user 13 belongs, from the three types of product introduction pages 92-1 to 92-3 stored in the content storage unit 57. As a result, the display unit 44 displays the product introduction page 92-2.

The user 13, who has viewed the product introduction page 92-2 and decided to purchase the bag 71, clicks on the purchase button 92-2a included in the product introduction page 92-2 to access the bag 71. As a result, the provision unit 59 performs processing to purchase the bag 71 and provides the bag 71 to the user 13 as an interaction. After obtaining the bag 71, the user 13 uses the provision device 11 to enter an evaluation value 94 for the bag 71 as a product review. The evaluation value 94 is transmitted to the information processing device 12.

As described above, the information processing device 12 provides the user 13 with the advertisement 91-1 having the largest first transmission degree, and provides the user 13 with the product introduction page 92-2 having the largest second transmission degree. This allows the user 13, who is estimated to be truly satisfied with the bag 71, i.e., who is estimated to input a high evaluation value 94, to be directed to the bag 71 via the advertisement 91-1 and the product introduction page 92-2.

### <Another Exemplary Overview of Processing by Information Processing System>

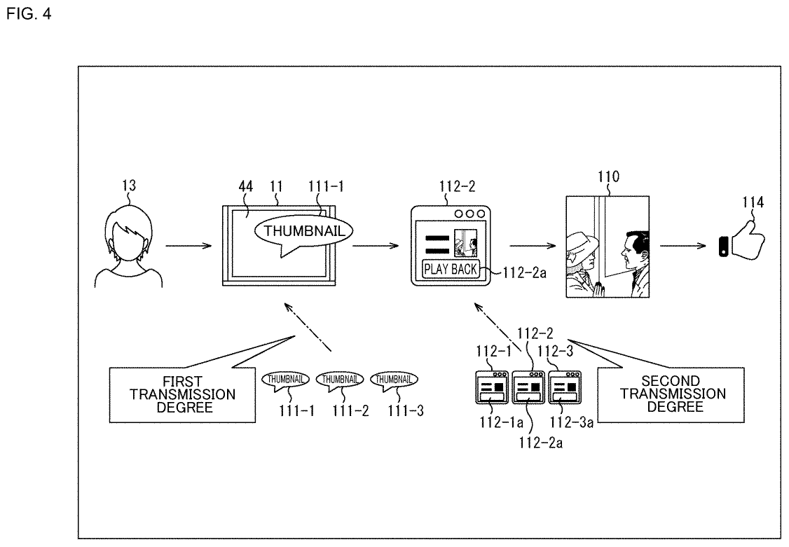

FIG. 4 illustrates another exemplary overview of processing performed by the information processing system 10.

In the example shown in FIG. 4, the user 13 plays back a movie using a video distribution service. In this case, the target content is the movie 110 to be played back. The first measure content is, for example, a thumbnail related to the movie 110, and the second measure content is, for example, a page that provides a summarized description of the movie 110.

Although not shown, the information processing system 10 first calculates the first and second transmission degrees by having the provision device 11 display a randomly selected thumbnail and a summarized description page selected by the information processing device 12 similarly to the case described with reference to FIG. 2.

Next, the information processing system 10 optimizes the first measure and second measure content to be provided to the user 13 on the basis of the first and second transmission degrees, similarly to the case described with reference to FIG. 3.

Specifically, in the example shown in FIG. 4, thumbnails 111-1 to 111-3 are stored in the content storage unit 57 as three types of selection candidates for first measure content. The content storage unit 57 also stores summarized description pages 112-1 to 112-3 as three types of selection candidates for second measure content. The summarized description pages 112-1 to 112-3 include playback buttons 112-1a to 112-3a, respectively that are operated when playing back the movie 110.

As shown in FIG. 4, when the user 13 has accessed the first measure content by operating the provision device 11, the selection unit 56 selects the thumbnail 111-1 that has the largest first transmission degree for the segment to which the user 13 belongs, among the three types of thumbnails 111-1 to 111-3 stored in the content storage unit 57. As a result, the display unit 44 displays the thumbnail 111-1.

The user 13, who has viewed the thumbnail 111-1 and become interested in the movie 110, clicks on the thumbnail 111-1 to access the second measure content. As a result, the selection unit 56 selects the summarized description page 112-2, which has the highest second transmission degree for the segment to which user 13 belongs, among the three types of summarized description pages 112-1 to 112-3 stored in the content storage unit 57. As a result, the display unit 44 displays the summarized description page 112-2.

The user 13, who has viewed the summarized description page 112-2, and decides to play back the movie 110, the user carries out clicking on the play button 112-2a included in the summarized description page 112-2 to access the movie 110. As a result, the provision unit 59 performs processing to play back the movie 110 and provides the movie 110 to the user 13 as an interaction. After watching the movie 110, the user 13 uses the provision device 11 to input an evaluation value 114 for the movie 110 as a viewing review. The evaluation value 114 is transmitted to the information processing device 12.

As described above, the information processing device 12 provides the user 13 with the thumbnail 111-1 having the largest first transmission degree, and provides the user 13 with the summarized description page 112-2 having the largest second transmission degree. This allows the user 13, who is estimated to be truly satisfied with the movie 110 i.e., to input a high evaluation value 114, to be directed to the movie 110 via the thumbnail 111-1 and the summarized description page 112-2.

The information processing system 10 can also be used for services other than EC services and video distribution services. For example, the information processing system 10 can also be used for services that provide news sites, blogs, or information sharing tools. This can prevent users, who are estimated to input low evaluation values after viewing only part of an article on news sites, blogs, or information-sharing tools, from being directed to those news sites, blogs, or information-sharing tools.

The information processing system 10 can also be used for distribution services for example for music, games, and books. This can prevent users, who are estimated to input low evaluation values after using only part of music, games, and books from being directed to the music, games, and books.

The information processing system 10 can also be used in recruitment services. This can prevent users with low interest in a company from being directed to that company.

### <Example of User Information Table>

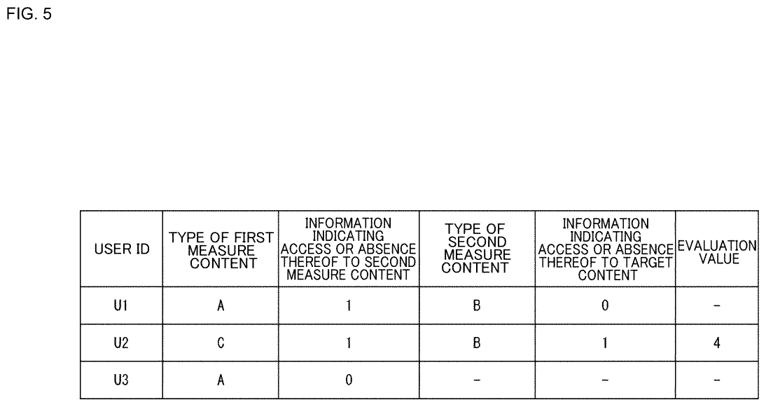

FIG. 5 illustrates an example of a user information table.

In the example in FIG. 5, access information about three users 13 is registered, corresponding to the user IDs “U1,” “U2,” and “U3” of the users 13. In other words, there are three entries registered in the user information table in FIG. 5.

Specifically, the first entry includes the user ID “U1,” the type of the first measure content “A,” “1” as information indicating whether there has been access to the second measure content, the type of the second measure content “B,” “0” as information indicating whether there has been access to the target content, and indicating that no evaluation value is registered.

In this case, the user 13, who has the user ID “U1” and has been provided with the first measure content of type A, has accessed the second measure content, but has not accessed the target content via the second measure content of type B provided through this. Therefore, the first measure content of type A has not been able to accurately convey the content of the target content to the user 13.

The second entry includes the user ID “U2,” the type of first measure content “C,” “1” as information indicating whether there has been access to the second measure content, the type of second measure content “B,” “1” as information indicating whether there has been access to the target content, and “4” as the evaluation value.

In this case, the user 13, who has the user ID “U2” and has been provided with the first measure content of type C, has accessed the second measure content, and has accessed the target content via the second measure content of type B provided through this. In addition, since the evaluation value for the target content given by the user 13 is 4 out of 5, the user 13 is satisfied with the target content. Therefore, for the user 13, the first measure content of type C and the second measure content of type B are able to accurately convey the content of the target content.

As the third entry, the user ID “U3,” the type of the first measure content “A,” “0” as information indicating whether there has been access to the second measure content, “-” indicating that no type of second measure content is registered, “0” as information indicating whether there has been access to the target content, and “.” indicating that no evaluation value is registered.

In this case, the user 13, who has the user ID “U3,” has been provided with the first measure content of type A, but has not accessed the second measure content. Therefore, the first measure content of type A is not effective in directing the user 13 to the target content.

### <Another Example of User Characteristic Information>

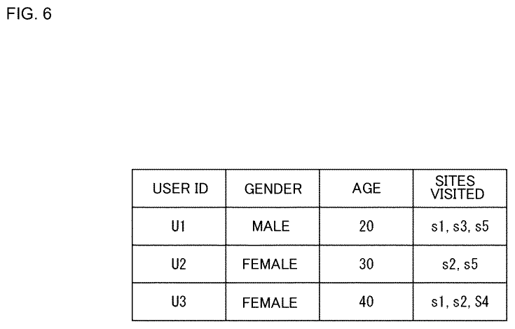

FIG. 6 illustrates an example of user characteristic information.

FIG. 6 shows an example of user characteristic information for three users 13. In the example in FIG. 6, the user characteristic information for one user 13 includes a user ID “U1,” gender “male,” age “20,” and the Uniform Resource Locators (URLs) of the sites visited, “s1,” “s3,” and “s5.”

The user characteristic information for another user 13 includes a user ID “U2,” gender “female,” age “30,” and the URLs of the sites visited “s2” and “s5.” The user characteristic information for the last user 13 includes a user ID “U3,” gender “female,” age “40,” and the URLs of the sites visited “s1,” “s2,” and “s4.”

In the example in FIG. 6, if the users 13 are segmented by gender, the user 13 with the user ID “U1” is classified into segment A. The user 13 with the user ID “U2” and the user 13 with the user ID “U3” are classified into segment B, which is different from segment A.

In the above description, the users 13 are segmented by gender, but the same is true for segmentation by age group or by sites visited. As for segmentation methods, in addition to the method of classifying segments using a predetermined threshold, there are also methods that classify segments using clustering techniques such as the hierarchical clustering, the principal component analysis, and the k-means method.

### <Description of User Information Table Registration Processing>

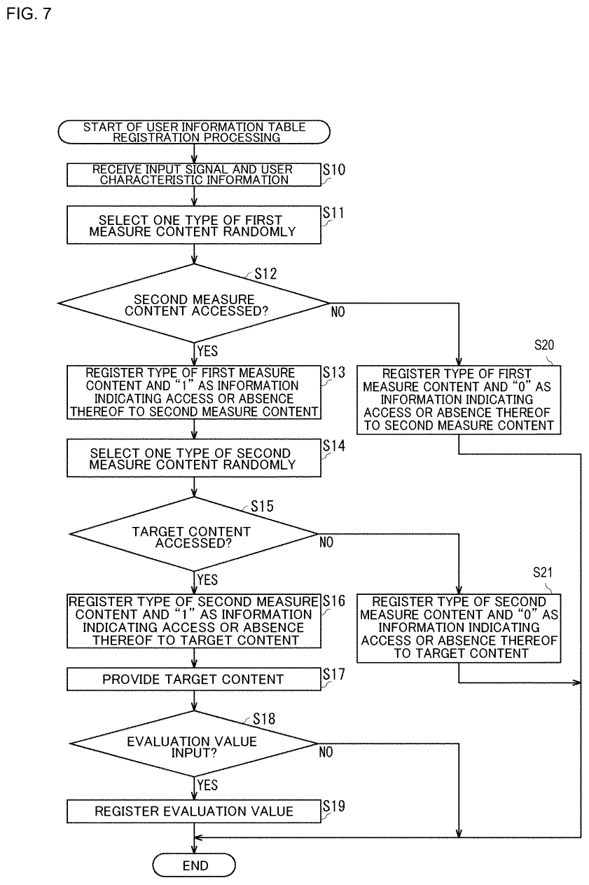

FIG. 7 is a flowchart for illustrating user information table registration processing performed by the information processing device 12 to calculate the first and second transmission degrees. The user information table registration processing starts, for example, when an input signal indicating access to the first measure content and user characteristic information are transmitted from the transmission unit 42 before the first and second transmission degrees are calculated.

In step S10 in FIG. 7, the receiving unit 51 receives an input signal indicating access to the first measure content and user characteristic information transmitted from the transmission unit 42 and supplies them to the selection unit 56.

In step S11, the selection unit 56 randomly selects one type of first measure content from multiple types of first measure content stored in the content storage unit 57. The selection unit 56 then reads the selected first measure content from the content storage unit 57 and supplies it to the supply unit 58. As a result, this first measure content is displayed on the display unit 44. The selection unit 56 supplies the type of the selected first measure content to the log storage unit 52.

In step S12, the receiving unit 51 determines whether the user 13 has accessed the second measure content. Specifically, the receiving unit 51 determines whether an input signal indicating access to the second measure content has been received together with the same user characteristic information as that received from the transmission unit 42 in step S10. If it is determined that the user characteristic information and the input signal have been received, the receiving unit 51 determines that user 13 has accessed the second measure content. The receiving unit 51 then supplies the received user characteristic information and the input signal to the log storage unit 52 and the selection unit 56, and the process proceeds to step S13.

In step S13, the log storage unit 52 registers the type of the first measure content supplied by the selection unit 56 in step S11 and “1” as information indicating whether there has been access to the second measure content in the user information table stored therein. Specifically, the log storage unit 52 registers the user ID included in the user characteristic information supplied by the receiving unit 51 in a new entry in the user information table stored therein. The log storage unit 52 also registers the type of first measure content and “1” as information indicating whether there has been access to the second measure content in this entry.

In step S14, the selection unit 56 randomly selects one type of second measure content from multiple types of second measure content stored in the content storage unit 57. The selection unit 56 then reads the selected second measure content from the content storage unit 57 and supplies it to the supply unit 58. As a result, the second measure content is displayed on the display unit 44. The selection unit 56 supplies the type of the selected second measure content to the log storage unit 52.

In step S15, the receiving unit 51 determines whether the user 13 has accessed the target content. Specifically, the receiving unit 51 determines whether an input signal indicating access to the target content has been received from the transmission unit 42 together with the same user characteristic information as that received in step S10. If it is determined that the user characteristic information and the input signal have been received, the receiving unit 51 determines that the user 13 has accessed the target content. The receiving unit 51 then supplies the received user characteristic information and the input signal to the log storage unit 52 and the provision unit 59, and the process proceeds to step S16.

In step S16, the log storage unit 52 registers, in the user information table, in the entry registered in step S13, the type of second measure content represented by the information supplied from the selection unit 56 in step S14 and “1” as information indicating whether there has been access to the target content.

In step S17, the provision unit 59 provides the target content to the user 13 identified by the user ID included in the user characteristic information.

In step S18, the receiving unit 51 determines whether the user 13 has input an evaluation value. Specifically, the receiving unit 51 determines whether an input signal indicating the evaluation value has been received from the transmission unit 42, together with the same user characteristic information as that received in step S10. If it is determined that the user characteristic information and the evaluation value have been received, the receiving unit 51 determines that the user 13 has input the evaluation value. The receiving unit 51 then supplies the received user characteristic information and the evaluation value to the log storage unit 52, and the process proceeds to step S19.

In step S19, the log storage unit 52 registers the evaluation value represented by the input signal in the entry registered in step S13 in the user information table, and then the process ends.

Meanwhile, if the receiving unit 51 has not received, from the transmission unit 42, an input signal indicating access to the second measure content together with the same user characteristic information as that received in step S10, it is determined in step S12 that the user 13 has not accessed the second measure content.

Then, in step S20, the log storage unit 52 registers the type of the first measure content supplied by the selection unit 56 in step S11 and “0” as information indicating whether there has been access to the second measure content in the user information table stored therein. Specifically, the log storage unit 52 registers the user ID included in the user characteristic information supplied from the receiving unit 51 in a new entry in the user information table stored therein. The log storage unit 52 also registers the type of the first measure content and “0” as information indicating whether there has been access to the second measure content. The process then ends. Therefore, in this case, the new entry includes the type of the second measure content, information indicating whether there has been access to the target content, and “-,” as an evaluation value, indicating that no evaluation value is registered.

In addition, if the receiving unit 51 has not received, from the transmission unit 42, an input signal indicating access to the target content together with the same user characteristic information as that received in step S10, the receiving unit determines in step S15 that the user 13 has not accessed the target content.

Then, in step S21, the log storage unit 52 registers the type of the second measure content supplied by the selection unit 56 in step S14 and “0” as information indicating whether there has been access to the target content in the entry registered in step S13 in the user information table. The process then ends. Therefore, in this case, the entry registered in the user information table in step S13 has “-” registered as the evaluation value, indicating that no evaluation value is registered.

If the receiving unit 51 has not received an input signal from the transmission unit 42 indicating the evaluation value together with the same user characteristic information as that received in step S10, the receiving unit determines in step S18 that the user 13 has not input the evaluation value, and the process ends. Therefore, in this case, the entry registered in the user information table in step S13 is registered with “-” as the evaluation value indicating that no evaluation value is registered.

When the user information table registration processing in FIG. 7 is repeatedly performed until the number of entries for users 13 belonging to each segment, which is registered in the user information table for each type of the first measure content, reaches a prescribed number, the calculation unit 53 calculates the first transmission degree and has it stored in the transmission degree storage unit 55. When the user information table registration processing in FIG. 7 is repeatedly performed until the number of entries for users 13 belonging to each segment, which is registered in the user information table reaches a prescribed number for each type of the second measure content, the calculation unit 53 calculates the second transmission degree and has it stored in the transmission degree storage unit 55.

### <Description of Optimization Processing>

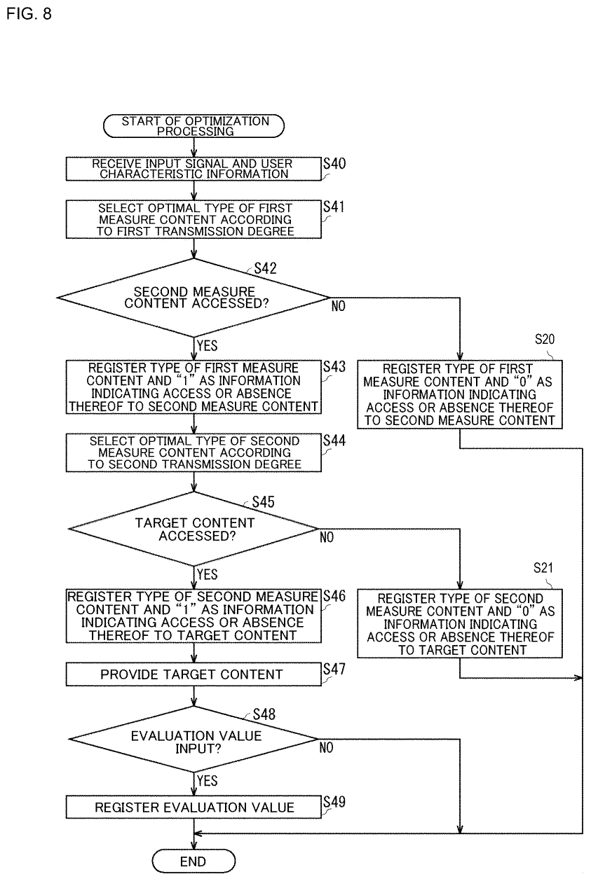

FIG. 8 is a flowchart for illustrating optimization processing performed by the information processing device 12 after calculation of the first and second transmission degrees. The optimization processing starts, for example, when an input signal indicating access to the first measure content and user characteristic information are transmitted from the transmission unit 42 after calculation of the first and second transmission degrees.

In step S40 in FIG. 8, the receiving unit 51 receives the input signal indicating access to the first measure content and the user characteristic information transmitted from the transmission unit 42 and supplies them to the selection unit 56.

In step S41, the selection unit 56 selects the optimal type of first measure content from the types of first measure content stored in the content storage unit 57 on the basis of the first transmission degree corresponding to the user characteristic information supplied by the receiving unit 51. Specifically, the selection unit 56 recognizes the segment corresponding to the user characteristic information on the basis of the user characteristic information. The selection unit 56 reads out the first transmission degree of each type of first measure content corresponding to the segment from the transmission degree storage unit 55, and selects the type of first measure content that is optimal on the basis of the first transmission degree.

The selection unit 56 then reads out the selected type of first measure content from the content storage unit 57 and supplies it to the supply unit 58. As a result, the first measure content is displayed on the display unit 44. The selection unit 56 supplies the type of the selected first measure content to the log storage unit 52.

The processing in steps S42 and S43 is the same as the processing in steps S12 and S13 in FIG. 7, and therefore the description will not be provided.

In step S44, the selection unit 56 selects the optimal type of second measure content from the types of second measure content stored in the content storage unit 57 on the basis of the second transmission degree corresponding to the user characteristic information supplied by the receiving unit 51. Specifically, the selection unit 56 recognizes the segment corresponding to the user characteristic information on the basis of the user characteristic information. The selection unit 56 reads out the second transmission degree of each type of second measure content corresponding to the segment from the transmission degree storage unit 55, and selects the optimal type of second measure content on the basis of the second transmission degree.

The selection unit 56 then reads out the selected type of second measure content from the content storage unit 57 and supplies it to the supply unit 58. As a result, the second measure content is displayed on the display unit 44. The selection unit 56 supplies the selected type of second measure content to the log storage unit 52.

The processing in steps S45 to S51 is the same as the processing in steps S15 to S21 in FIG. 7, and therefore the description will not be provided.

The calculation unit 53 calculates and updates the first transmission degree at prescribed timing according to the user information table updated in the optimization processing in FIG. 8. Similarly, the calculation unit 54 calculates and updates the second transmission degree.

As described above, the information processing device 12 selects the first measure content and the second measure content to be provided to the prescribed user 13 on the basis of the user information about the user 13 who has accessed the target content among the users 13 who have accessed the second measure content via the first measure content and the evaluation value for the target content by the user 13 who has accessed the target content via the second measure content.

Specifically, the information processing device 12 calculates the first transmission degree on the basis of the user information about the user 13 who has accessed the target content among the users 13 who have accessed the second measure content via the first measure content. The information processing device 12 then selects, for example, the first measure content that has the largest first transmission degree as the first measure content to be provided to the prescribed user 13. The information processing device 12 calculates the second transmission degree on the basis of the evaluation value of the target content by the user 13 who has accessed the target content via the second measure content. Then, the information processing device 12 selects, for example, the second measure content that has the largest second transmission degree as the second measure content to be provided to the prescribed user 13. As a result, it is possible to direct appropriate users who are presumed to be truly interested in the target content and who are likely to enter high evaluation values to the target content via the first measure content and the second measure content. In other words, it is possible to narrow down the target users to those with high user engagement.

In contrast, if the first measure content and second measure content are selected simply to maximize the benefits, such as the rate of access to the target content, then inappropriate users may also be directed to the target content. The inappropriate users are, for example, users who view the first measure content and second measure content and are disappointed to find that the actual target content is different from their expectations, and who are not actually interested or satisfied with the target content. If such inappropriate users are directed to the target content, the evaluation values for the target content may decrease, and there is a risk that this may have a negative impact on the reputation of the target content.

For example, if the first measure content and the second measure content are selected so as to maximize the number of purchases of the target content, which is a product in EC, the first measure content and the second measure content may be content that excessively exaggerates the content of the target content without considering the user's level of satisfaction.

When the first measure content and second measure content are selected to maximize the number of accesses to the target content, which is a news site or video, the first measure content and the second measure content may be fraudulent content that does not accurately represent the content of the news site article or video.

In these cases, the target content that the user expects to see upon viewing the first measure content and second measure content differs from the actual target content, and the user may enter a low value as the evaluation value for the target content. As a result, the reputation of the target content deteriorates.

In addition, the information processing device 12 calculates the first and second transmission degrees for each segment. Therefore, the number of entries registered in the user information table required for calculating the first and second transmission degrees can be reduced. As a result, the optimization of the first measure content and the second measure content can be started in a short period of time.

In contrast, it is difficult to provide the same user 13 with multiple types of first measure content and second measure content, and to make the user access the second measure content or the target content. Therefore, it is difficult to calculate the first transmission degree of each type of first measure content and the second transmission degree of each type of second measure content for each user 13.

In the above description, the selection unit 56 optimizes the first measure content and the second measure content individually, but the combination of the first measure content and the second measure content may be optimized.

In this case, for example, the selection unit 56 calculates the total transmission degree using the first and second transmission degrees corresponding to the user characteristic information supplied by the receiving unit 51, according to the following expression (5).

$$\begin{matrix}[ Math . 5 ] & \\ t r = α \cdot {tr}_{1}^{c 1 , u} + ( 1 - α ) \cdot {tr}_{2}^{c 2 , u} u ∈ U , c 1 ∈ C 1 , c 2 ∈ C 2 & ( 5 )\end{matrix}$$

In expression (5), u, c1, c2, tr₁^{c1, u}, and tr₂^{c2, u} are the same as those in the expressions (1) and (2) described above, In the expression, α is a value of 0 or greater and 1 or smaller, and tr is the total transmission degree.

According to expression (5), the total transmission degree is a linear sum of the first transmission degree and the second transmission degree. The selection unit 56 selects a combination of the first measure content type and the second measure content type for which the total transmission degree is maximum on the basis of the total transmission degree.

The selection unit 56 may calculate the total transmission degree, not only on the basis of the first transmission degree and the second transmission degree, but also on the basis of the similarity between the first measure content and the second measure content. In this case, the selection unit 56 calculates the total transmission degree, for example, according to the following expression (6).

$$\begin{matrix}[ Math . 6 ] & \\ t r = α \cdot {tr}_{1}^{c 1 , u} + ( 1 - α ) \cdot {tr}_{2}^{c 2 , u} + {sim}_{c 1 , c 2} u ∈ U , c 1 ∈ C 1 , c 2 ∈ C 2 & ( 6 )\end{matrix}$$

In expression (6), u, c1, c2, tr₁^{c1, u}, tr₂^{c2, u}, α, and tr are the same as those in expression (5) above. Sim_{c1, c2} is the similarity between the first measure content of type c1 and the second measure content of type c2. Similarity is an indicator that takes on a high value when, for example, the same keywords or images are used. Specifically, when the first measure content and the second measure content include text, similarity is calculated for example using TF-IDF (Term Frequency-Inverse Document Frequency) or Dec2Vec. When the first measure content and the second measure content include images, the similarity is calculated for example using MSE (mean squared error), PSNR (peak signal-to-noise ratio), or SSIM (Structual SIMilarity).

According to expression (6), the similarity between the first measure content and the second measure content increases as the total transmission degree increases. Therefore, the selection unit 56 can improve the consistency of the first measure content and the second measure content by selecting a combination of the type of the first measure content and the type of the second measure content for which the total transmission degree calculated by expression (6) is the largest, compared to the case where the total transmission degree is calculated by expression (5). This can, for example, improve the brand image of the target content.

The first transmission degree and the second transmission degree may be estimated using a machine learning model. In this case, the calculation unit 53 trains a machine learning model that estimates p (first transmission degree|segment, type of first measure content) on the basis of the user information table. This machine learning model is then stored in the transmission degree storage unit 55 in place of the first transmission degree. The selection unit 56 uses this machine learning model to estimate the first transmission degree for each type of first measure content corresponding to the segment to which the user 13 belongs, and selects the type of first measure content for which the first transmission degree is estimated to be maximized. In the same way, for the second measure content, the calculation unit 54 uses a machine learning model to estimate p (second transmission degree|segment, second measure content type) to estimate the second transmission degree, and selects the type of second measure content for which the second transmission degree is estimated to be maximized. For the machine learning model, a supervised machine learning model such as linear regression, decision tree, support vector regression, and neural network can be used.

When the first transmission degree and the second transmission degree are estimated using the machine learning models, it may be possible to estimate the first transmission degree and the second transmission degree for each user using the characteristics of the user 13 represented by the user characteristic information. In this case, a machine learning model that estimates p (first transmission degree|user characteristics, first measure content type) and a machine learning model that estimates p (second transmission degree|user characteristics, second measure content type) are trained.

The selection unit 56 may calculate a common first transmission degree and a common second transmission degree for all users 13, rather than calculating a first transmission degree and a second transmission degree for each segment.

The first and second transmission degrees may be calculated using a causal inference method. Details of the causal inference method are disclosed, for example, in “Introduction to Impact Evaluation: Causal Inference for Accurate Comparisons/Fundamentals of Econometrics” by Shota Yasui, published by Gijutsu-Hyohron Co., Ltd. in 2020, and “Tools of Causal Inference” by Shoki Okubo, published by Japanese Association For Mathematical Sociology in 2019.

The selection unit 56 may optimize the selection algorithm that selects the first measure content for which for example the effect of the first transmission degree increase range is maximized, and may select the first measure content using the optimized selection algorithm. The same applies to the second measure content.

### Second Embodiment

### <Exemplary Configuration of Information Processing System>

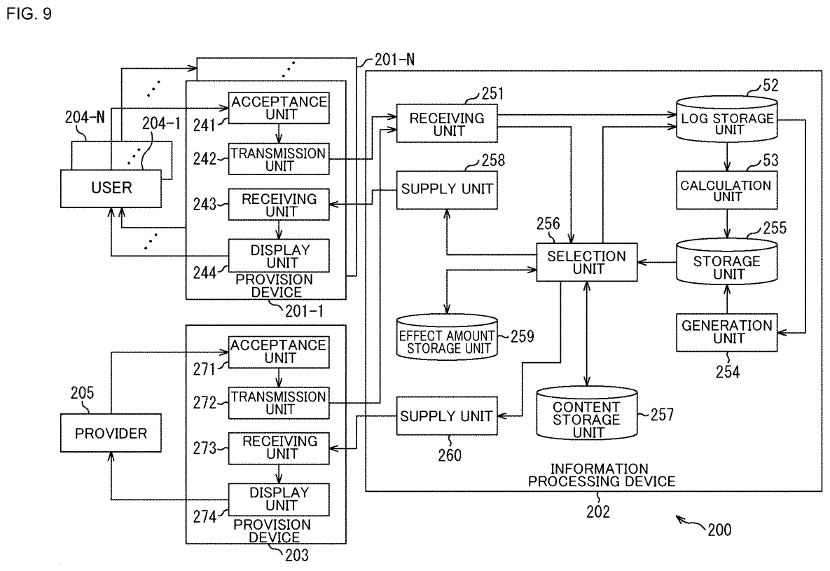

FIG. 9 is a block diagram of a configuration example of an information processing system including an information processing device according to a second embodiment to which the present technology is applied.

In the information processing system 200 in FIG. 9, portions corresponding to those of the information processing system 10 in FIG. 1 are denoted by the same reference numerals. Therefore, description of the corresponding portions will be omitted as appropriate, and the description will focus on the portions different from the information processing system 10. Information processing system 200 is different from the information processing system 10 in that the second measure content is a service such as a customer service or a response service that directs users to the target content provided by the target content provider, and that the second measure content is selected on the basis of an effect estimation model, and otherwise is configured in the same way as information processing system 10.

The information processing system 200 illustrated in FIG. 9 includes N provision devices 201-1 to 201-N, an information processing device 202, and a provision device 203 which are connected to each other over a network. The information processing system 200 directs users 204-1 to 204-N, who use the respective provision devices 201-1 to 201-N, to target content. According to the second embodiment, the target content is, for example, a product being advertised. In the following, when it is not necessary to distinguish between the provision devices 201-1 to 201-N, these devices are collectively referred to as provision device 201. Similarly, the users 204-1 to 204-N are collectively referred to as user 204.

The provision device 201 includes an acceptance unit 241, a transmission unit 242, a receiving unit 243, and a display unit 244.

The acceptance unit 241 accepts an operation from the user 204 and supplies an input signal indicating input content corresponding to the operation to the transmission unit 242. Specifically, the acceptance unit 241 accepts a prescribed operation from the user 204 to access the first measure content and supplies an input signal indicating access to the first measure content as input content to the transmission unit 242. According to the second embodiment, the first measure content is content such as advertisements. Similarly to the first embodiment, multiple types of first measure content are provided for a single piece of target content. The acceptance unit 241 accepts an input operation from the user 204 for the target content, and supplies an input signal indicating an evaluation value for the target content to the transmission unit 242.

The transmission unit 242 transmits the input signal supplied by the acceptance unit 241, together with user characteristic information about the user 204, to the information processing device 202 over a network that is not shown.

The receiving unit 243 receives the first measure content transmitted from the information processing device 202 over a network that is not shown and supplies the content to the display unit 244.

The display unit 244 (user display unit) displays the first measure content supplied from the receiving unit 243 to the user 204. If the user 204 becomes interested in the target content after viewing the first measure content displayed on the display unit 244, the user accesses the second measure content. Similarly to the first embodiment, according to the second embodiment, multiple types of second measure content are provided for a single piece of target content.

The information processing device 202 has substantially the same configuration as the information processing device 12 with the difference being that the information processing device 202 includes a receiving unit 251, a generation unit 254, a storage unit 255, a selection unit 256, a content storage unit 257, and a supply unit 258, instead of the receiving unit 51, the calculation unit 54, the transmission degree storage unit 55, the selection unit 56, the content storage unit 57, and the supply unit 58, that the information processing device 202 does not include the provision unit 59, and that the information processing device 202 includes a newly-added effect amount storage unit 259 and a supply unit 260.

The receiving unit 251 receives an input signal and user characteristic information transmitted from the provision devices 201 and 203 over a network that is not shown. The receiving unit 251 also supplies the input signal indicating an evaluation value and the user characteristic information transmitted from the provision device 201 to the log storage unit 52. The receiving unit 251 also supplies access to the second measure content or the target content and the user characteristic information transmitted from the provision device 203 to the log storage unit 52.

The receiving unit 251 supplies an input signal indicating access to the first measure content and user characteristic information transmitted from the provision device 201 to the selection unit 256. The receiving unit 251 also supplies an input signal indicating access to the second measure content and user characteristic information transmitted from the provision device 203 to the selection unit 256.

The generation unit 254 segments users 204-1 to 204-N into groups on the basis of users 204 that have common characteristics according to user characteristic information about each user 204. For each segment, the generation unit 254 obtains the types of second measure content and evaluation values accessed by the users 204 belonging to the segment from the user information table stored in the log storage unit 52.

Using these pieces of information, the generation unit 254 trains a machine learning model that estimates p (effect amount of second measure content|segment, type of second measure content), and generates an effect estimation model. According to the effect estimation model, it is possible to estimate the effect amount, which represents the amount of effect of directing the user 204, by the second measure content, to the target content on the basis of the segment to which the user 204 belongs and the type of the second measure content. The amount of effect of the second measure content on each segment in the effect estimation model is expressed by the following expression (7).

$$\begin{matrix}[ Math . 7 ] & \\ {τ}_{c 2} = 𝔼 [ {Y}^{( 1 )} ] - 𝔼 [ {Y}^{( 0 )} ] c 2 ∈ C 2 & ( 7 )\end{matrix}$$

In expression (7), c2 represents each type in a set C2 of all types of second measure content. Y is an evaluation value. Y⁽¹⁾ is an evaluation value for the target content accessed via second measure content of type c2 by the user 204 belonging to each segment. Y⁽⁰⁾ is an evaluation value for the target content by the user 204 belonging to each segment when the second measure content is not provided. In addition, τ_{c2} is an effect amount for each segment of the second measure content of type c2.

According to the second embodiment, as will be described, the selection unit 256 may also choose not to provide the second measure content without selecting the type of second measure content. Therefore, an entry for the case where the second measure content is not provided is also registered in the user information table. The evaluation value registered in this entry is used as Y⁽⁰⁾.

Y may be information indicating whether there has been access to the target content, rather than the evaluation value. In addition, it may be possible to estimate both the effect amount when Y is an evaluation value and the effect amount when Y is information indicating whether there has been access to the target content. In this case, the selection unit 256, which will be described, selects the second measure content by referring to both the effect amounts.

The generation unit 254 supplies an effect estimation model generated for each segment and for each type of second measure content to the storage unit 255 for storage.

The storage unit 255 stores the first transmission degree supplied by the calculation unit 53 and the effect estimation model supplied by the generation unit 254.

The selection unit 256 selects one type of first measure content randomly or according to the first transmission degree in response to the input signal, similarly to the selection unit 56. The selection unit 256 supplies the type of the selected first measure content to the log storage unit 52. The selection unit 256 reads out the selected first measure content from the content storage unit 257 and supplies it to the supply unit 258.

The selection unit 256 selects one type of second measure content randomly in response to the input signal, similarly to the selection unit 56.

Alternatively, the selection unit 256 reads out, in response to an input signal, an effect estimation model for the segment corresponding to the user characteristic information supplied from the receiving unit 251 together with the input signal from the storage unit 255. Using the effect estimation model, the selection unit 256 estimates an effect amount for the second measure content for the segment corresponding to the user characteristic information for each type of second measure content. The selection unit 256 temporarily stores the estimated effect amount of each type of second measure content in the effect amount storage unit 259.

The selection unit 256 selects the optimal type of second measure content on the basis of the effect amounts of all types of second measure content stored in the effect amount storage unit 259. Specifically, the selection unit 256 selects the type of second measure content corresponding to the maximum value if the maximum value among the effect amounts of all types of second measure content is equal to or greater than a threshold value. Meanwhile, if the maximum value is less than the threshold value, the selection unit 256 selects the option of not providing the second measure content.

Upon selecting a type of second measure content, the selection unit 256 supplies the type to the log storage unit 52. In addition, the selection unit 256 reads out second measure content information representing the content of the type of second measure content from the content storage unit 257. The selection unit 256 reads out the first measure content information related to the first measure content that has been accessed before the second measure content from the content storage unit 257. The selection unit 256 supplies this first measure content information together with the second measure content information to the supply unit 260.

Meanwhile, upon selecting not to provide the second measure content, the selection unit 256 supplies information indicating “none” as the type of second measure content to the log storage unit 52. As a result, “-” indicating no registration is registered as the type of second measure content in the user information table stored in the log storage unit 52. The selection unit 256 generates information indicating that the second measure content is not provided as the second measure content information and supplies the information to the supply unit 260.

The content storage unit 257 stores multiple types of first measure content, in association with the first measure content information for each first measure content. The content storage unit 257 stores the second measure content information for multiple types of second measure content.

The supply unit 258 (first supply unit) supplies (transmits) the first measure content supplied by the selection unit 256 to the provision device 201 of the user 204 corresponding to the user characteristic information referenced by the selection unit 256 when making a selection over a network which is not shown. The first measure content is received by the receiving unit 243 and displayed on the display unit 244.

The effect amount storage unit 259 temporarily stores the effect amount of each type of second measure content supplied by the selection unit 256.

The supply unit 260 (second supply unit) supplies (transmits) the first measure content information and the second measure content information supplied from the selection unit 256 to the provision device 203 of the provider 205 that provides (implements) the second measure content to the user 204 over a network that is not shown. The second measure content is received by the provision device 203 and displayed to the provider 205.

The provision device 203 may be a personal computer, or a tablet terminal. The provision device 203 includes an acceptance unit 271, a transmission unit 272, a receiving unit 273, and a display unit 274. The provision device 203 is used by the provider 205.

The acceptance unit 271 accepts an operation from the provider 205 and supplies an input signal representing the input content corresponding to the operation to the transmission unit 272. Specifically, the acceptance unit 271 accepts an input operation from the provider 205 indicating that the user 204 has accessed the second measure content, and supplies an input signal indicating that the second measure content has been accessed as the input content to the transmission unit 272. The acceptance unit 271 accepts an input operation from the provider 205 indicating that the user 204 has accessed the target content, and supplies an input signal indicating that the target content has been accessed as input content to the transmission unit 272.

The transmission unit 272 transmits the input signal supplied by the acceptance unit 271 to the information processing device 202 over a network that is not shown together with user characteristic information about the user 204 corresponding to the input signal. The user characteristic information is, for example, obtained from the user 204 by the provider 205 using a membership card or point card, and is supplied to the transmission unit 272 via the acceptance unit 271 for example by performing an input operation. The user characteristic information may be automatically input into the provision device 203 using for example face recognition technology or beacons.

The receiving unit 273 receives the first measure content information and the second measure content information transmitted from the supply unit 260 over a network which is not shown and supplies these pieces of information to the display unit 274.

The display unit 274 (provider display unit) displays the first measure content information and the second measure content information supplied by the receiving unit 273 to the provider 205. The provider 205 provides or does not provide the second measure content to the user 204 according to the second measure content information displayed on the display unit 274. The provider 205 also refers to the first measure content information as required when providing the second measure content.

If the user 204 becomes interested in the target content for example due to the second measure content provided by the provider 205, the user accesses the target content. The provider 205 performs an input operation to indicate that the user 204 has accessed the target content in response to the user 204 accessing the target content. After accessing the target content, the user 204 performs an input operation to enter an evaluation value for the target content using the provision device 201.

### <Exemplary Overview of Processing by Information Processing System>

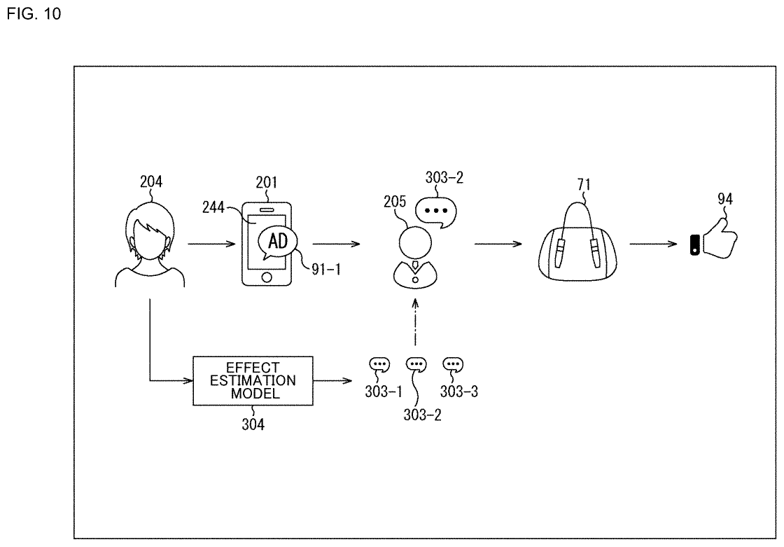

FIG. 10 illustrates an exemplary overview of processing performed by the information processing system 200 in FIG. 9.

In FIG. 10, portions corresponding to those in FIG. 3 are denoted by the same reference numerals. Therefore, the descriptions of the corresponding portions will be omitted as appropriate, and the description will focus on the portions different from those in FIG. 3.

In the example in FIG. 10, the user 204 purchases the bag 71 advertised in the advertisement at a physical store. In this case, similarly to the examples in FIGS. 2 and 3, the target content is the bag 71, and the first measure content is the advertisement for the bag 71. In the example in FIG. 10, the second measure content is customer service provided at the physical store selling the bag 71, and the second measure content information is the customer service content information that expresses the content of the customer service. The provider 205 is, for example, a clerk in a physical store.

Although not shown, the information processing system 200 first performs the same processing as that shown in FIG. 2. Specifically, the information processing system 200 has an advertisement randomly selected by the information processing device 202 displayed at the provision device 201. The information processing system 200 causes the information on the content of the customer service selected randomly or the information on the customer service content information that indicates the randomly selected customer service has not been provided to be displayed on the provision device 203. As a result, the information processing device 202 generates the first transmission degree and an effect estimation model 304.

After that, if the user 204 accesses the first measure content by operating the provision device 201, the information processing system 200 optimizes the first measure content provided to the user 204 on the basis of the first transmission degree, similarly to the case described with reference to FIG. 3. As a result, as shown in FIG. 10, the display unit 44 displays the advertisement 91-1 with the highest first transmission degree for the segment to which the user 204 belongs.

When the user 204 who has viewed the advertisement 91-1 becomes interested in the bag 71 and comes to the actual store to purchase the bag 71, the information processing system 200 optimizes the second measure content to be provided to the user 204 on the basis of the effect estimation model 304.

Specifically, in the example in FIG. 10, the customer service content information 303-1 to 303-3 is stored in the content storage unit 257 as the second measure content information for the three types of selection candidates for the second measure content. When the user 204 visits the physical store, the provider 205 for example performs an input operation, to indicate that the user 204 has accessed the second measure content. As a result, the transmission unit 272 transmits user characteristic information about the user 204 and an input signal indicating access to the second measure content to the information processing device 202.

As a result, using the effect estimation model 304, the selection unit 256 estimates the effect amount of each customer service corresponding to the three types of customer service content information 303-1 to 303-3 for the segment to which the user 204 belongs. In the example in FIG. 10, the maximum value for the effect amount is the effect amount corresponding to the customer service content information 303-2, and is equal to or more than a threshold. Therefore, the selection unit 256 selects the customer service corresponding to the customer service content information 303-2 as the optimal second measure content. As a result, the display unit 274 displays the customer service content information 303-2. The threshold is set on the basis of, for example, the amount of increase in sales corresponding to the cost of customer service and the amount of effect.

The provider 205, who has viewed the customer service content information 303-2, provides customer service according to the customer service content information 303-2. This allows the provider 205 to provide customer service that improves the evaluation value to be given after the purchase of the bag 71 by the user 204.

If the user 204 decides to purchase the bag 71 as a result of the customer service, the user 204 can access the bag 71 by completing the purchase procedure, such as payment. As a result, the provider 205 provides the bag 71 to the user 204. After obtaining the bag 71, the user 204 uses the provision device 201 to input an evaluation value 94 for the bag 71 as a product review. The evaluation value 94 is transmitted to the information processing device 202.

As described above, the information processing device 202 provides the advertisement 91-1, which has the highest first transmission degree, to the user 204, and provides the customer service content information 303-2, which has the highest effect amount and is equal to or greater than the threshold, to the provider 205. This allows the user 204 who is estimated to be truly satisfied with the bag 71, i.e., to input a high evaluation value 94, to be directed to the bag 71 via the customer service corresponding to the advertisement 91-1 and the customer service content information 303-2.

In the example in FIG. 10, the maximum value of the effect amount was equal to or greater than the threshold value, but if it is less than the threshold value, the selection unit 256 makes a selection not to provide the second measure content. As a result, the customer service content information indicating non-customer service is displayed on the display unit 274 as the content of the customer service. As a result, the provider 205 does not provide the customer service.

In this way, if the effect amount is less than the threshold value regardless of which of the customer service content information 303-1 to 303-3 is selected, that is, if there is little possibility that the user 204 will purchase the bag 71, the provider 205 will not provide customer service. Therefore, the cost of serving users 204 who are unlikely to purchase the bag 71 can be reduced. According to the second embodiment, the second measure content is a service provided by the provider 205, and therefore the cost of the second measure content is greater than that in the first embodiment, where the second measure content is a product introduction page. Therefore, the effect of the reduction is significant.

In the example in FIG. 10, the first measure content is an advertisement displayed on the provision device 201, similarly to the examples in FIGS. 2 and 3, but the first measure content may be for example a paper flyer. In this case, the provision device 201 includes a printing unit instead of the display unit 244, and the printing unit provides the first measure content to the user 204 by printing the first measure content on paper.

In the example in FIG. 10, the user 204 purchases the bag 71 advertised in an advertisement at a physical store, but the information processing system 200 also performs the same processing when the user 204 uses the customer service or response service provided at a call center.

### <Display Example of Second Measure Content Information>

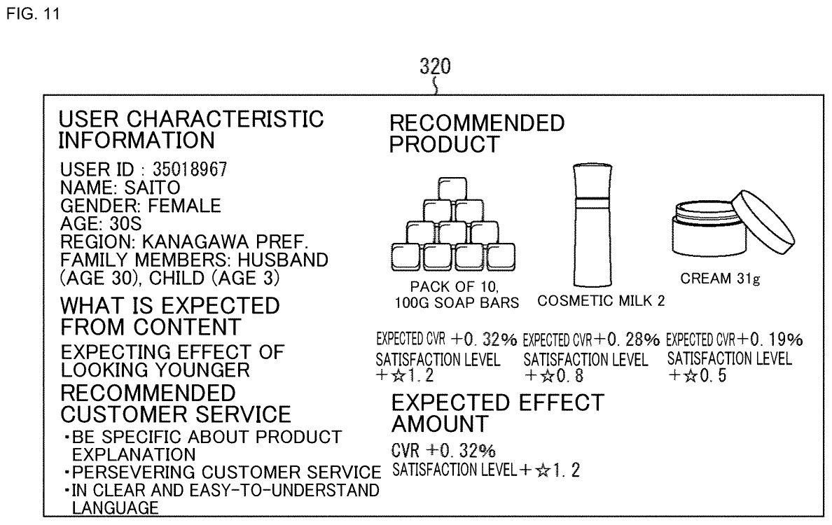

FIG. 11 shows an example of display on a screen as a user interface (UI) that includes the second measure content information displayed on the display unit 274.

In the example in FIG. 11, the target content is a group of cosmetic products including multiple cosmetic products sold at a prescribed physical store, the first measure content is an advertisement for the group of cosmetic products, and the second measure content is customer service at the physical store selling the group of cosmetic products. The provider 205 is a clerk at the physical store.

In the example in FIG. 11, user characteristic information is displayed in the upper left of the screen 320 displayed in the display unit 274. In the example in FIG. 11, the user characteristic information includes user ID, name, gender, age, region, and family members.

In the left center part of the screen 320, the first measure content information is displayed as what is expected from the content. In the example in FIG. 11, the first measure content accessed by the user 204 is an advertisement promoting the effect of making the user look younger, and, therefore, the first measure content information represents the insight of “expecting the effect of looking younger.” Therefore, “expecting effect of looking younger” is displayed as what is expected from the content. In addition, as what is expected from the content, the content related to the websites visited by the user 204 included in the user characteristic information may be displayed as an insight.

In the lower left of the screen 320, the second measure content information about the optimized second measure content is displayed as a recommended customer service approach. In the example in FIG. 11, the second measure content is persevering customer service that specifically explains about products in clear and easy-to-understand language. Therefore, as a recommended customer service, “be specific when explaining about products,” “persevering customer service,” and “in clear and easy-to-understand language” are displayed as the second measure content information.

In the lower right of the screen 320, the estimated value of the effect amount of the selected second measure content is displayed as the expected effect amount when recommended customer service is executed. Specifically, the effect amount is displayed as the rate of increase in the level of satisfaction. In FIG. 11, the effect amount is displayed as the rate of increase in CVR (conversion rate) when Y in the above-mentioned expression (7) is information indicating whether there has been access to the target content, but the CVR does not have to be displayed.

The provider 205 who has viewed this screen 320 provides the user 204 with the second measure content that is optimal for the user 204 according to the recommended customer service.

In the example in FIG. 11, the target content is not a single cosmetic product, but a group of multiple cosmetic products. Therefore, the amount of effect for each of the cosmetic products of the cosmetic products group may be estimated. In this case, as shown in the upper right of the screen 320 in FIG. 11, the image and name of each cosmetic product are displayed, and the estimated amount of effect is displayed as the rate of increase in the level of satisfaction. In this case, similarly to the lower right of the screen 320, the rate of increase in CVR may also be displayed.

The display unit 274 may display information on products that the user 204 is presumed to desire, among the products sold by the provider 205, by performing natural language processing such as pattern matching based on the first measure content information.

### <Description of Processing Performed by Information Processing Device>

The user information table registration processing performed by the information processing device 202 for calculating a first transmission degree and generating an effect estimation model is the same as the user information table registration processing in FIG. 7, except that the choice of not providing the second measure content is also included as a candidate for selecting the second measure content, and therefore the description will not be provided.

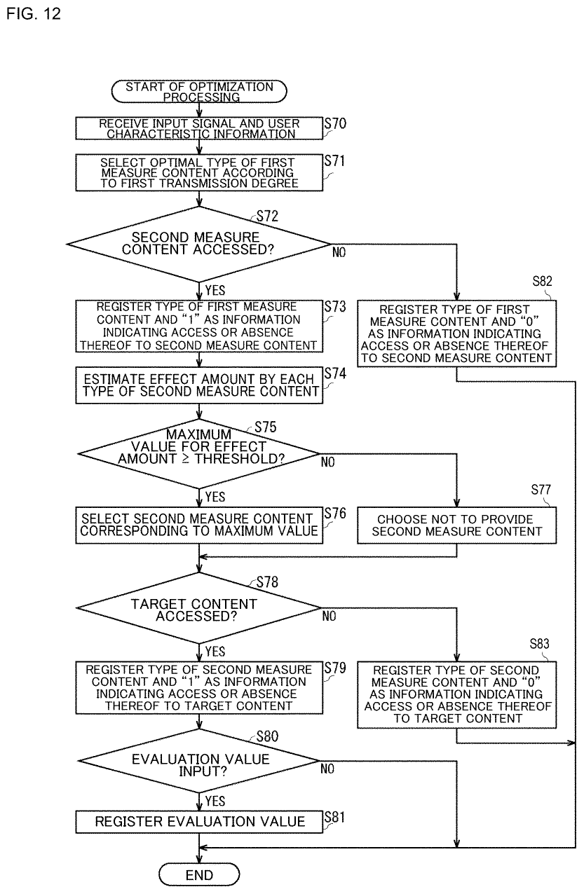

FIG. 12 is a flowchart for illustrating the optimization processing performed by the information processing device 202 after the first transmission degree is calculated and the effect estimation model is generated. This optimization processing starts, for example, when an input signal indicating access to the first measure content and user characteristic information are transmitted from the transmission unit 242 after calculation of the first transmission degree and generation of the effect estimation model.

The processing in steps S70 and S71 in FIG. 12 is the same as the processing in steps S50 and S51 in FIG. 8, and therefore the description will not be provided.

In step S72, the receiving unit 251 determines whether the user 204 has accessed the second measure content. Specifically, the receiving unit 251 determines whether an input signal indicating access to the second measure content has been received, together with the same user characteristic information as that received from the transmission unit 272 in step S70. If it is determined that the user characteristic information and the input signal have been received, the receiving unit 251 determines that the user 204 has accessed the second measure content. The receiving unit 251 then supplies the received user characteristic information and input signal to the log storage unit 52 and selection unit 256, and the process proceeds to step S73.

In step S73, the log storage unit 52 registers the type of the first measure content supplied from the selection unit 256 in step S71 and “1” as information indicating whether there has been access to the second measure content in the user information table, similarly to step S13 in FIG. 7.

In step S74, the selection unit 256 reads the effect estimation model for the segment corresponding to the user characteristic information supplied by the receiving unit 251 from the storage unit 255, and estimates an effect amount using the effect estimation model for each type of second measure content. The selection unit 256 supplies the estimated effect amount of each type of second measure content to the effect amount storage unit 259 and temporarily stores it.

In step S75, the selection unit 256 determines whether the maximum value of the effect amounts of all types of second measure content temporarily stored in the effect amount storage unit 259 is equal to or greater than a threshold value. If the maximum value is determined to be equal to or greater than the threshold value in step S75, the process proceeds to step S76.

In step S76, the selection unit 256 selects the second measure content corresponding to the maximum value as an optimal second measure content. The selection unit 256 then reads the second measure content information for the selected second measure content from the content storage unit 257 and supplies it to the supply unit 260. As a result, the second measure content information is displayed on the display unit 274. The selection unit 256 supplies the type of the selected second measure content to the log storage unit 52. Then, the process proceeds to step S78.

Meanwhile, if it is determined in step S75 that the maximum value of the effect amounts is not equal to or greater than the threshold value, the process proceeds to step S77. In step S77, the selection unit 256 chooses not to provide the second measure content. The selection unit 256 then supplies information indicating “none” as the type of second measure content to the log storage unit 52. The selection unit 256 also generates information indicating that the second measure content is not provided as second measure content information and supplies it to the supply unit 260. As a result, the second measure content information is displayed on the display unit 274. Then, the process proceeds to step S78.

In step S78, the receiving unit 251 determines whether the user 204 has accessed the target content. Specifically, the receiving unit 251 determines whether an input signal indicating access to the target content has been received from the transmission unit 272, together with the same user characteristic information as that received in step S70. If it is determined that the user characteristic information and input signal have been received, the receiving unit 251 determines that the user 204 has accessed the target content. The receiving unit 251 then supplies the received user characteristic information and input signal to the log storage unit 52, and the process proceeds to step S79.

In step S79, the log storage unit 52 registers, in the entry registered in step S73 in the user information table, the type of second measure content and “1” as information indicating whether the target content has been accessed supplied from the selection unit 256 in step S76 or S77.

In step S80, the receiving unit 251 determines whether the user 204 has input an evaluation value. Specifically, the receiving unit 251 determines whether an input signal indicating the evaluation value has been received from the transmission unit 242, together with the same user characteristic information as that received in step S70. If it is determined that the user characteristic information and the evaluation value have been received, the receiving unit 251 determines that the user 204 has input the evaluation value. The receiving unit 251 then supplies the received user characteristic information and the evaluation value to the log storage unit 52, and the process proceeds to step S81.

In step S81, the log storage unit 52 registers the evaluation value represented by the input signal in the entry registered in step S73 in the user information table, and then the process ends.

Meanwhile, if the receiving unit 251 does not receive, from the transmission unit 272, an input signal indicating access to the second measure content, together with the same user characteristic information as that received in step S70, it is determined in step S72 that the user 204 has not accessed the second measure content.

Then, in step S82, the log storage unit 52 registers the type of the first measure content supplied by the selection unit 256 in step S71 and 0 as information indicating whether there has been access to the second measure content in the user information table, similarly to step S20 in FIG. 7. Then, the process ends. Therefore, in this case, the new entry in which the type of the first measure content is for example registered has the type of the second measure content, information indicating whether access to the target content has been made, and “-” indicating that no registration is registered.

In addition, if the receiving unit 251 does not receive, from the transmission unit 272, an input signal indicating access to the target content, together with the same user characteristic information as that received in step S70 it determines in step S78 that the user 204 has not accessed the target content.

Then, in step S83, the log storage unit 52 registers the type of the second measure content and “0” as information indicating whether there has been access to the target content, which are supplied from the selection unit 256 in step S76 or S77, in the entry registered in step S73 in the user information table. Then, the process ends. Therefore, in this case, the entry registered in step S73 in the user information table has “-” registered as the evaluation value, indicating no registration.

If the receiving unit 251 does not receive, from the transmission unit 242, an input signal indicating an evaluation value together with the same user characteristic information as that received in step S70, it is determined in step S80 that the user 204 has not input an evaluation value, and the process ends. Therefore, in this case, “-” indicating no registration is registered as an evaluation value in the entry in the user information registered in step S73.

The calculation unit 53 recalculates and updates the first transmission degree at prescribed timing based on the user information table updated in the optimization processing in FIG. 12. The generation unit 254 also generates and updates the effect estimation model at prescribed timing based on the user information table updated in the optimization processing in FIG. 12.

As described above, the information processing device 202 selects the first measure content and the second measure content to be provided to a prescribed user 204 on the basis of the user information about the users 204 who have accessed the target content among the users 204 who have accessed the second measure content via the first measure content and the evaluation values for the target content by the users 204 who have accessed the target content via the second measure content.

Specifically, similarly to the information processing device 12, the information processing device 202 selects, for example, the first measure content that provides the first measure content with the largest first transmission degree to the prescribed user 204. The information processing device 202 generates an effect estimation model based on the evaluation value of the target content for the user 204 who has accessed the target content via the second measure content. The information processing device 202 then selects the second measure content to be provided to the prescribed user 204, for example, the second measure content for which the estimated effect amount using the effect estimation model is the largest. As a result, appropriate users who are truly interested in the target content and are estimated to enter a high evaluation value can be directed to the target content via the first measure content and the second measure content.

In addition, if the maximum estimated effect value is not equal to or greater than the threshold, the information processing device 202 chooses not to provide the second measure content. This prevents the second measure content from being provided to users 204 with low effect values and poor cost performance for the second measure content. As a result, the cost performance of the second measure content for all users 204 is improved.

In addition, an effect estimation model that estimates p (effect value of the second measure content|user characteristics, type of second measure content) for each user using the characteristics represented by the user characteristic information about each user 204 may be generated. In this case, the effect value is estimated using a method such as regression analysis.

When an effect estimation model is generated for each user using the characteristics of the user 204, the random selection of the second measure content performed when generating the effect estimation model does not have to be strictly random, and the selection can be made according to a certain rule. In this case, the effect amount can be estimated using methods such as propensity score matching or inverse probability weighting (IPW).

If Y in the above expression (7) is information indicating whether there has been access to the target content, then the probability of the user 204 accessing the target content can be improved by optimizing the second measure content.

In addition, if Y in the above expression (7) is the ratio of the number of accesses to the target content to the number of accesses to the second measure content, then the ratio can be improved by optimizing the second measure content.

According to the first and second embodiments, it is assumed that there are two types of measure content that direct users to the target content, but the number of measure contents is not limited to this.

### <Computer>

The above-described series of processing can also be performed by hardware or software. When the series of steps of processing is performed by software, a program of the software is installed in a computer. Here, the computer includes a computer embedded in dedicated hardware or, for example, a general-purpose personal computer capable of executing various functions by installing various programs.

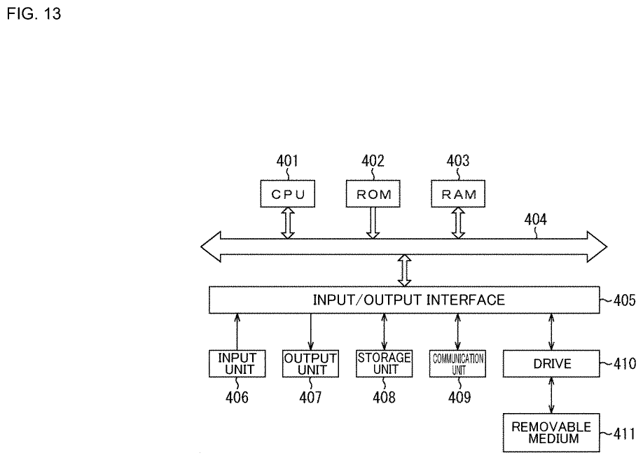

FIG. 13 is a block diagram showing an example of a hardware configuration of a computer that executes the above-described series of processing according to a program.

In the computer, a central processing unit (CPU) 401, a read-only memory (ROM) 402, and a random access memory (RAM) 403 are connected to each other by a bus 404.

An input/output interface 405 is further connected to the bus 404. An input unit 406, an output unit 407, a storage unit 408, a communication unit 409, and a drive 410 are connected to the input/output interface 405.

The input unit 406 is constituted by a keyboard, a mouse, a microphone, or the like. The output unit 407 includes a display, a speaker, and the like. The storage unit 408 is a hard disk, non-volatile memory, or the like. The communication unit 409 is a network interface or the like. The drive 410 drives a removable medium 411 such as a magnetic disk, an optical disc, a magneto-optical disk, or a semiconductor memory.

In the computer configured as described above, for example, the CPU 401 loads a program stored in the storage unit 408 into the RAM 403 via the input/output interface 405 and the bus 404 and executes the program to perform the above-described series of processing.

The program executed by the computer (the CPU 401) can be recorded on, for example, the removable medium 411 serving as a package medium for supply. The program can be supplied via a wired or wireless transfer medium such as a local area network, the Internet, or digital satellite broadcasting.

In the computer, by mounting the removable medium 411 on the drive 410, it is possible to install the program in the storage unit 408 via the input/output interface 405. The program can be received by the communication unit 409 via a wired or wireless transfer medium to be installed in the storage unit 408. In addition, this program may be installed in advance in the ROM 402 or the storage unit 408.

Note that the program executed by a computer may be a program that performs processing chronologically in the order described in the present specification or may be a program that performs processing in parallel or at a necessary timing such as a called time.

The embodiments of the present technology are not limited to the aforementioned embodiments, and various changes can be made without departing from the gist of the present technology.

For example, a combination of all or part of the above-mentioned plurality of embodiments may be employed. For example, in the first embodiment, the second measure content may be provided to the provider who provides the second measure content to the user similarly to the second embodiment. In the second embodiment, the second measure content is the same as that in the first embodiment, and may be provided to the provision device used by the user.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in a case in which one step includes a plurality of processes, the plurality of processes included in the one step can be executed by one device or executed in a shared manner by a plurality of devices.

The advantageous effects described in the present specification are merely exemplary and are not limited, and other advantageous effects of the advantageous effects described in the present specification may be achieved.

The present technology can be configured as follows.

(1)

An information processing device comprising a selection unit configured to select a first measure content to be provided to a prescribed user among multiple first measure contents with different measures for inducement to target content and select a second measure content to be provided to the prescribed user among multiple second measure contents with different measures for directing a user who has accessed the selected first measure content to the target content,
wherein
the selection unit is configured to select the first measure content and the second measure content on the basis of user information about a user who has accessed the target content among users who have accessed the second measure content via the first measure content and evaluation value for the target content by a user who has accessed the target content via the second measure content.
   (2)

The information processing device according to (1), wherein the user information is the ratio of the number of users who have accessed the target content via the second measure content to the number of users who have accessed the second measure content via the first measure content.

(3)

The information processing device according to (1) or (2), wherein the selection unit is configured to select the first measure content and the second measure content on the basis of the user information about the user having a common characteristic to the prescribed user and the evaluation value.

(4)

The information processing device according to any one of (1) to (3), further comprising a first calculation unit configured to calculate a first transmission degree as a transmission degree for the first measure content on the basis of the user information for each of the first measure contents, and
a second calculation unit configured to calculate a second transmission degree as a transmission degree for the second measure content on the basis of the evaluation value for each of the second measure contents, wherein
wherein
the selection unit is configured to select the first measure content and the second measure content on the basis of the first transmission degrees for the multiple first measure contents and the second transmission degrees for the multiple second measure contents.
   (5)

The information processing device according to (4), wherein the selection unit is configured to select the first measure content on the basis of the first transmission degree for each of the multiple first measure contents and select the second measure content on the basis of the second transmission degree for each of the multiple second measure contents.

(6)

The information processing device according to (4), wherein the selection unit selects the first measure content and the second measure content on the basis of a total transmission degree calculated using the first transmission degree for the first measure content and the second transmission degree for the second measure content for each of combinations of the first measure contents and the second measure contents.

(7)

The information processing device according to (6), wherein the total transmission degree is calculated also on the basis of similarity between the first measure content and the second measure content.

(8)

The information processing device according to any one of (1) to (3), further comprising a generation unit configured to generate an effect amount estimation model that estimates an effect amount that indicates an effect amount by each of the multiple second measure contents to direct the prescribed user to the target content on the basis of the evaluation values corresponding to the multiple second
measure contents,
wherein
the selection unit is configured to estimate the effect amount by each of the multiple second measure contents using the model generated by the generation unit and select the second measure content on the basis of the effect amount.
   (9)

The information processing device according to (8), wherein the generation unit is configured to generate the model on the basis of the evaluation value by the user having a characteristic common to that of the prescribed user.

(10)

The information processing device according to (8) or (9), wherein the effect amount is the evaluation value.

(11)

The information processing device according to any one of (8) to (10) wherein the selection unit is configured to select the second measure content when the effect amount is equal to or greater than a prescribed threshold.

(12)

The information processing device according to any one of (1) to (11), further comprising a supply unit configured to supply the first measure content and the second measure content selected by the selection unit to the display unit that performs display to the prescribed user.

(13)

The information processing device according to any one of (1) to (11), further comprising a first supply unit configured to supply the first measure content selected by the selection unit to a user display unit that performs display to the prescribed user, and a second supply unit configured to supply second measure content information that represents the content of the second measure content selected by the selection unit at a provider display unit that performs display to a provider that provides the second measure content to the prescribed user.

(14)

The information processing device according to (13), wherein the second supply unit is configured to also supply, to the provider display unit, information related to the first measure content selected by the selection unit.

(15)

An information processing method comprising the step of causing an information processing device to select a first measure content to be provided to a prescribed user among multiple first measure contents with different measures for inducement to target content and to select a second measure content to be provided to the prescribed user among multiple second measure contents with different measures for directing a user who has accessed the selected first measure content to the target content,
wherein
in processing in the selection step, the first measure content and the second measure content are selected on the basis of user information which is information about a user who has accessed the target content among users who have accessed the second measure content via the first measure content and an evaluation value for the target content by a user who has accessed the target content via the second measure content.
   (16)

A program causing a computer to function as
an information processing device comprising a selection unit configured to select a first measure content to be provided to a prescribed user among multiple first measure contents with different measures for inducement to target content and select a second measure content to be provided to the prescribed user among multiple second measure contents with different measures for directing a user who has accessed the selected first measure content to the target content,
wherein
the selection unit is configured to select the first and second measure contents on the basis of user information about a user who has accessed the target content among users who have accessed the second measure content via the first measure content and an evaluation value for the target content by a user who has accessed the target content via the second measure content.

### REFERENCE SIGNS LIST

12 Information processing device
13-1 to 13-N User
44 Display
53, 54 Calculation unit
56 Selection unit
58 Supply unit
71 Bag
72 Advertisement
73 Product introduction page
74 Evaluation value
91-1 to 91-3 Advertisement
92-1 to 92-3 Product introduction page
94 Evaluation value
110 Movie
111-1 to 111-3 Thumbnail
112-1 to 112-3 Overview description page
114 Evaluation value
202 Information processing device
204-1 to 204-N User
205 Provider
244 Display
254 Generation unit
256 Selection unit
258 Supply unit
260 Supply unit
274 Display
303-1 to 303-3 Customer service content information
304 Effect estimation model

What is claimed is:

1. An information processing device comprising a selection unit configured to select a first measure content to be provided to a prescribed user among multiple first measure contents with different measures for inducement to target content and select a second measure content to be provided to the prescribed user among multiple second measure contents with different measures for directing a user who has accessed the selected first measure content to the target content,
wherein
the selection unit is configured to select the first measure content and the second measure content on the basis of user information about a user who has accessed the target content among users who have accessed the second measure content via the first measure content and evaluation value for the target content by a user who has accessed the target content via the second measure content.

2. The information processing device according to claim 1, wherein the user information is the ratio of the number of users who have accessed the target content via the second measure content to the number of users who have accessed the second measure content via the first measure content.

3. The information processing device according to claim 1, wherein the selection unit is configured to select the first measure content and the second measure content on the basis of the user information about the user having a common characteristic to the prescribed user and the evaluation value.

4. The information processing device according to claim 1, further comprising a first calculation unit configured to calculate a first transmission degree as a transmission degree for the first measure content on the basis of the user information for each of the first measure contents, and
a second calculation unit configured to calculate a second transmission degree as a transmission degree for the second measure content on the basis of the evaluation value for each of the second measure contents,
wherein
the selection unit is configured to select the first measure content and the second measure content on the basis of the first transmission degrees for the multiple first measure contents and the second transmission degrees for the multiple second measure contents.

5. The information processing device according to claim 4, wherein the selection unit is configured to select the first measure content on the basis of the first transmission degree for each of the multiple first measure contents and select the second measure content on the basis of the second transmission degree for each of the multiple second measure contents.

6. The information processing device according to claim 4, wherein the selection unit selects the first measure content and the second measure content on the basis of a total transmission degree calculated using the first transmission degree for the first measure content and the second transmission degree for the second measure content for each of combinations of the first measure contents and the second measure contents.

7. The information processing device according to claim 6, wherein the total transmission degree is calculated also on the basis of similarity between the first measure content and the second measure content.

8. The information processing device according to claim 1, further comprising a generation unit configured to generate an effect amount estimation model that estimates an effect amount that indicates an effect amount by each of the multiple second measure contents to direct the prescribed user to the target content on the basis of the evaluation values corresponding to the multiple second measure contents,
wherein
the selection unit is configured to estimate the effect amount by each of the multiple second measure contents using the model generated by the generation unit and select the second measure content on the basis of the effect amount.

9. The information processing device according to claim 8, wherein the generation unit is configured to generate the model on the basis of the evaluation value by the user having a characteristic common to that of the prescribed user.

10. The information processing device according to claim 8, wherein the effect amount is the evaluation value.

11. The information processing device according to claim 8, wherein the selection unit is configured to select the second measure content when the effect amount is equal to or greater than a prescribed threshold.

12. The information processing device according to claim 1, further comprising a supply unit configured to supply the first measure content and the second measure content selected by the selection unit to the display unit that performs display to the prescribed user.

13. The information processing device according to claim 1, further comprising a first supply unit configured to supply the first measure content selected by the selection unit to a user display unit that performs display to the prescribed user, and a second supply unit configured to supply second measure content information that represents the content of the second measure content selected by the selection unit at a provider display unit that performs display to a provider that provides the second measure content to the prescribed user.

14. The information processing device according to claim 13, wherein the second supply unit is configured to also supply, to the provider display unit, information related to the first measure content selected by the selection unit.

15. An information processing method comprising the step of causing an information processing device to select a first measure content to be provided to a prescribed user among multiple first measure contents with different measures for inducement to target content and to select a second measure content to be provided to the prescribed user among multiple second measure contents with different measures for directing a user who has accessed the selected first measure content to the target content,
wherein
in processing in the selection step, the first measure content and the second measure content are selected on the basis of user information which is information about a user who has accessed the target content among users who have accessed the second measure content via the first measure content and an evaluation value for the target content by a user who has accessed the target content via the second measure content.

16. A program for causing a computer to function as
an information processing device comprising a selection unit configured to select a first measure content to be provided to a prescribed user among multiple first measure contents with different measures for inducement to target content and select a second measure content to be provided to the prescribed user among multiple second measure contents with different measures for directing a user who has accessed the selected first measure content to the target content, wherein
the selection unit is configured to select the first measure content and the second measure content on the basis of user information about a user who has accessed the target content among users who have accessed the second measure content via the first measure content and an evaluation value for the target content by a user who has accessed the target content via the second measure content.
